(19) United States
(12) Patent Application Publication
(10) Pub. No.: US 2005/0225440 A1
(43) Pub. Date: Oct. 13, 2005

(54) Kid instant detection system (KIDS)

(76) Inventors: Lanny Clifton Simmons, Tampa, FL (US); Maria del Carmen Simmons, Tampa, FL (US)

Correspondence Address: LANNY C. SIMMONS, 6722 S. DAUPHIN AVE., TAMPA, FL, 33611, US

(21) Appl. No.: 10/817,176

(22) Filed: Apr. 5, 2004

(51) Int. Cl. B60Q 1/00

(52) U.S. Cl. 340/457; 340/573.4

(57) ABSTRACT

A device for detecting and sending a warning that a child has been left in a car unattended for a specified amount of time (to be determined) and when temperatures in the vehicle become too hot or too cold (to be determined. This invention is comprised of (1) a control module (2) a power indicator light (3) a reset button. (4) a sensing pad or switch which will make contact when the child is in the seat or vehicle, and (5) a wiring harness connecting the control box to the vehicle's electrical, horn, and lighting systems.

### BACKGROUND OF THE INVENTION

This invention is designed to prevent the loss of life of children being left in automobiles for extended periods of time and in extreme temperatures. Every year, children are unintentionally left in automobiles only to lose their lives. This device is designed to sound an alarm and notify parents or anyone in the area that a child had been left in the vehicle and is in danger.

### BRIEF DESCRIPTION OF DRAWINGS

FIG. 1 is a front perspective view of the Kid Instant Detection System (KIDS).

FIG. 2 is a front perspective view of the Kid Instant Detection System (KIDS) and illustrates how the invention integrates with the vehicle and child seat.

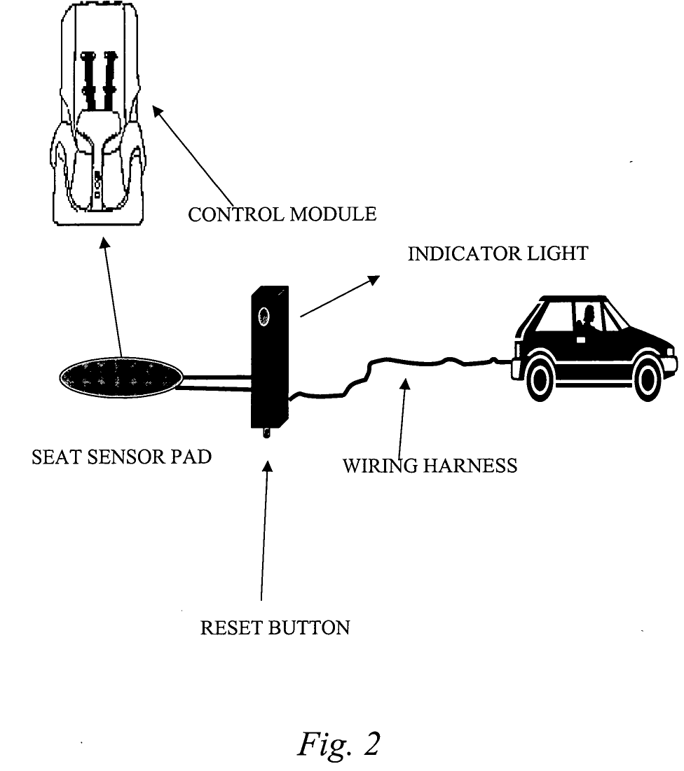

### DETAILED DESCRIPTION OF THE INVENTION

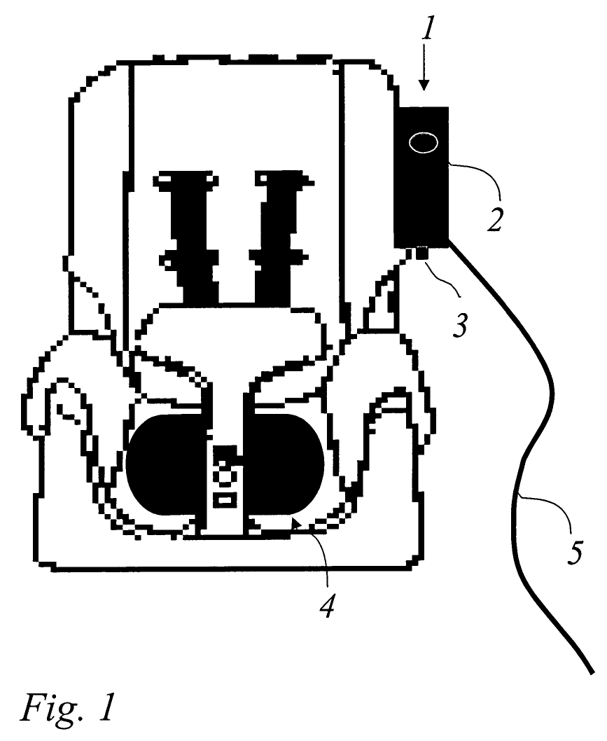

The Kid Instant Detection System shown in FIG. 1 comprises a control module assembly 1, a power indicator light 2, a reset button 3, a sensing pad or switch 4 which will make contact when the child is in the seat or vehicle and a wiring harness 5 connecting the control box to the vehicle's electrical, horn, and lighting systems.

The device will be powered by the vehicle's 12-volt electrical system when the vehicle is operating and by the battery when the vehicle is parked/engine not operating. The sensing switch/pad is attached to the seat bottom and held in place with Velcro. The control module can be mounted or attached to the seat structure itself. The device has two modes of operation, mode 1 and mode 2. In mode 1, the sensing switch/pad will detect when a child is in the seat. When the driver's door is opened, the timer will start. If the child is not removed from the vehicle within a specified period of time (for example 2 minutes), the control module will send a signal to the vehicle horn and lighting system causing intermittent sounding of the horn and flashing of the lights. The horn will continue to sound and lights will continue to flash until the child is removed from the car or the control module is manually reset. This can only be done by entering the vehicle and pushing the reset button.

In mode 2, the built-in temperature sensor will send a signal to the vehicle horn and lighting system causing intermittent sounding of the horn and flashing of the lights. Mode 2 is designed as a backup to mode 1. The timer in mode 1 will have already activated the system. However, mode 2 will activate regardless of and in addition to mode 1 when a child is left in the vehicle and the vehicle temperature ascends or descends to the limits set in the control module.

1. A life saving device comprising of a control module, a switch or sensing pad in the child seat which will make contact when the child is in the seat; and a wiring harness connecting the seat sensing switch/pad to the control module and subsequently to the vehicle's horn and lighting systems.

2. The device of claim 1, wherein the device will be powered by the vehicle's 12-volt electrical system when the vehicle is operating and by the battery when the vehicle is parked/engine not operating.

3. The device of claim 1, wherein the device has two modes of operation, mode 1 and mode 2.

4. The device of claim 1, wherein mode 1, the sensing switch/pad will detect when a child is in the seat.

5. The device of claim 1, wherein when the driver's door is opened, the timer will start.

6. The device of claim 1, wherein in mode 2, the built-in temperature sensor will send a signal to the vehicle's horn and lighting systems causing intermittent sounding of the horn and flashing of the lights.

7. The device of claim 1, wherein the control module comprises an internal temperature sensor, power on indicator light, reset button, and timer.
